(19) United States
(12) Patent Application Publication
(10) Pub. No.: US 2015/0045031 A1
(43) Pub. Date: Feb. 12, 2015

(54) METHODS, APPARATUSES AND COMPUTER PROGRAM PRODUCTS FOR OPTIMIZING MOBILITY IN HETEROGENEOUS NETWORKS

(71) Applicant: Nokia Corporation, Espoo (FI)

(72) Inventors: Jorma Kaikkonen, Oulu (FI); Lars Dalsgaard, Oulu (FI)

(21) Appl. No.: 14/387,226

(22) PCT Filed: Mar. 20, 2013
(86) PCT No.: PCT/FI2013/050310

§ 371 Date: Sep. 22, 2014

Related U.S. Application Data
(60) Provisional application No. 61/615,549, filed on Mar. 26, 2012.

(51) Int. Cl. H04W 36/00

(52) U.S. Cl. CPC H04W 36/0005
USPC 455/436

(57) ABSTRACT

An apparatus for facilitating mobility management may include a processor and memory storing executable computer code causing the apparatus to at least perform operations including receiving a mobility timer from a network device. The computer program code may further cause the apparatus to start a time period of the received mobility timer in response to entering a cell. The computer program code may further cause the apparatus to determine whether the cell is changed to a different cell prior to expiration of the time period associated with the mobility timer. Corresponding methods and computer program products are also provided.

### TECHNOLOGICAL FIELD

An embodiment of the present invention relates generally to wireless communication technology and, more particularly, relates to an apparatus, method and a computer program product for providing efficient and reliable mobility management in a communications network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. For instance, the evolved universal mobile telecommunications system (UMTS) terrestrial radio access network (E-UTRAN) is currently being developed. The E-UTRAN, which is also known as Long Term Evolution (LTE) or 3.9G, is aimed at upgrading prior technologies by improving efficiency, lowering costs, improving services, making use of new spectrum opportunities, and providing better integration with other open standards.

An advantage of E-UTRAN which continues to be shared with other preceding telecommunication standards is the fact that users are enabled to access a network employing such standards while remaining mobile. Thus, for example, users having mobile terminals equipped to communicate in accordance with such standards may travel vast distances while maintaining communication with the network. By providing access to users while enabling user mobility, services may be provided to users while the users remain mobile. However, the mobility of users typically requires the network to provide continuity of service to the mobile users by enabling a user's mobile terminal to be handed over between different serving stations within corresponding different cells or service areas. In this regard, mobility management may be utilized to identify and maintain communication connections to mobile terminals that may move throughout or connect to different networks.

Heterogeneous network operation has been introduced in the third generation partnership project (3GPP). Latency and power consumption may be beneficial for achieving good end user experience in a network, such as a heterogeneous network. Both latency and power consumption relate to mobility management. For example, by ensuring the connection of a mobile terminal to a correct node, the network may help to minimize latency. Power consumption may also be improved by ensuring that the mobile terminal is connected to the correct network layer/node based on the level of mobility of the mobile terminal.

In cellular systems such as, for example, LTE systems, mobility may be performed either in a non-active mode (e.g., idle mode) or an active mode (e.g. in a connected mode). For instance, in a LTE IDLE mode, mobility may be based on priority rules and on autonomous cell reselection of a mobile terminal guided and determined by defined rules and specifications (e.g., 3GPP specifications) and carried out by parameters given by the network. In a LTE Radio Resource Control (RRC) Connected mode, mobility may be based on mobile terminal assisted network controlled handover mobility in which the network may be completely in charge of the mobility decisions potentially based on mobile terminal measurement reports. In addition, both LTE IDLE and LTE Connected mode mobility may be based on mobile terminal measurements.

Heterogeneous networks may include some network deployments that are complex, such as, for example, hierarchical network layers (e.g., even under a same frequency layer). Given the complexity of heterogeneous networks, it typically becomes challenging to determine instances in which a mobile terminal should re-select or handover to a ‘small cell’ layer, to provide larger capacity on a smaller area, or determine instances in which it may be best to keep the mobile terminal on ‘larger’ cells offering good coverage and robust mobility and hence minimizing the need of re-selection/handovers.

In an instance in which a mobile terminal (e.g., User Equipment (UE)) is in an inactive or semi-inactive state, (e.g. in IDLE or connected with no or little traffic and hence potentially applying discontinuous reception (DRX)) the level of mobility of the mobile terminal may be an important factor when determining the best mobility management strategy to be applied. The level of mobility of the mobile terminal may be determined by the velocity of the mobile terminal, direction of the movement of the mobile terminal and size of a corresponding cell.

Problems may arise concerning mechanisms in which to reliably detect whether a mobile terminal may stay at an area of a corresponding cell for an extended period of time (e.g. semi-static) or whether the mobile terminal may continue or move to other cells. For instance, a mobile terminal may know its velocity, but it may not have other necessary information relevant for determining the level of mobility.

In view of the foregoing problems, it may be beneficial to provide a mechanism in which to more efficiently and reliably determine the mobility of a mobile terminal in a communications network.

### BRIEF SUMMARY

A method, apparatus and computer program product are therefore provided that may facilitate provision of mobility management of one or more communication devices in a communications system.

An example embodiment may facilitate provision of a mobility timer (also referred to herein as a low mobility timer) from a network device (e.g., an eNB) to a communication device (e.g., a UE). In response to the communication device entering a cell, the communication device may start a time period associated with the mobility timer. In an instance in which the communication device determines that a cell in which the UE was initially located is changed prior to the expiration of the time period associated with the mobility timer, the communication device may determine that its mobility status corresponds to a moving mobility status. On the other hand, in an instance in which the communication device determines that a cell in which the UE is currently located is not changed upon expiration of the time period associated with the mobility timer, the communication device may determine that its mobility state corresponds to a non-moving mobility state.

An example embodiment may therefore provide a more reliable and efficient manner for a network to manage different levels of mobility of communication devices.

In one example embodiment, a method for facilitating mobility management is provided. The method may include receiving a mobility timer from a network device. The method may further include starting, via an apparatus, a time period of the received mobility timer in response to entering a cell. The method may further include determining whether the cell is changed to a different cell prior to expiration of the time period associated with the mobility timer.

In another example embodiment, an apparatus for facilitating mobility management is provided. The apparatus may include a processor and a memory including computer program code. The memory and computer program code are configured to, with the processor, cause the apparatus to at least perform operations including receiving a mobility timer from a network device. The memory and computer program code are also configured to, with the processor, cause the apparatus to start a time period of the received mobility timer in response to entering a cell. The memory and computer program code are also configured to, with the processor, cause the apparatus to determine whether the cell is changed to a different cell prior to expiration of the time period associated with the mobility timer.

In another example embodiment, a computer program product for facilitating mobility management is provided. The computer program product includes at least one computer-readable storage medium having computer-readable program code portions stored therein. The computer-executable program code instructions may include program code instructions configured to facilitate receipt of a mobility timer from a network device. The program code instructions may also start, via an apparatus, a time period of the received mobility timer in response to entering a cell. The program code instructions may also determine whether the cell is changed to a different cell prior to expiration of the time period associated with the mobility timer.

In yet another example embodiment, an apparatus for facilitating mobility management is provided. The apparatus may include means for receiving a mobility timer from a network device. The apparatus may also include means for starting a time period of the received mobility timer in response to entering a cell. The apparatus may also include means for determining whether the cell is changed to a different cell prior to expiration of the time period associated with the mobility timer.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a wireless communications system according to an example embodiment of the invention;

FIG. 2 is a schematic diagram of a system for providing mobility management according to an example embodiment of the invention;

FIG. 3 is a block diagram of an apparatus for providing mobility management in a user terminal according to an example embodiment of the invention;

FIG. 4 is a block diagram of an apparatus embodied at a network device for providing mobility management according to an example embodiment of the invention;

FIG. 5 is a flowchart according to an example method for providing mobility management according to an example embodiment of the invention; and

FIG. 6 is another flowchart according to an example method for providing mobility management according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As referred to herein, mobility management may, but need not, relate to continually tracking the location of communication devices (e.g., mobile terminals (e.g., mobile phones, etc.), that are connected to a communication system (e.g., cells of a network(s)). In this regard, mobility management may be utilized to identify and maintain communication connections to communication devices that may move throughout or connect to various communication systems (e.g., cells of a network(s)).

As referred to herein, a heterogonous network (also referred to herein as HetNet) may, but need not, include multiple types of access nodes in a wireless network such as, for example, a wide area network (WAN) that may include one or more macrocells, picocells, femtocells, small cells, etc. in order to provide wireless coverage in an environment with a wide variety of wireless coverage zones/areas. In this regard, a HetNet may be a network with complex interoperation between macrocells, picocells, femtocells, small cells, and other networks (e.g., WLANs).

As referred to herein, in one example embodiment, a HetNet may be a 3GPP access network including multiple cells with different characteristics.

In an UMTS Terrestrial Radio Access Network (UTRAN) and an E-UTRAN, a mechanism has been specified for an IDLE state and a RRC Connected state in which to determine the ‘mobility state’ of a mobile terminal (e.g., User Equipment (UE)) and scaling the re-selection or handover (e.g., Time-To-Trigger) parameters for each state based on the amount of re-selections or handovers the mobile terminal has experienced during some period of time. As such, currently in a connected state, a network may be able to accumulate the number of handovers over some period and based on the accumulated number of handovers, the network may determine (and may signal) the suitable parameters for the mobility management of a mobile terminal (e.g., UE).

Additionally, existing or currently specified procedures may designate a slow moving UE as default. Thereafter, based on the amount of cell changes during a given time, a mobile terminal may estimate its mobility state as low, medium or high.

One drawback of the current approach is that it is based on a history of mobility of a mobile terminal (e.g., a UE) and typically does not distinguish between cell types. Another drawback of these existing mechanisms is that they typically lead to a general ‘down-scaling’ of the affected parameters which may lead to faster mobility procedures. This ‘down-scaling’ of affected parameters may be acceptable in a homogeneous network deployment. However, down-scaling' of affected parameters in instances of inbound mobility to small cells in a heterogeneous network deployment may not be preferred. For instance, fast moving mobile terminals (e.g., UEs) should preferably not enter small cells.

In addition, existing mechanisms typically utilize some positioning technology to determine the velocity and direction of the movement of a mobile terminal and may provide this information to the corresponding network such that the network may consider this information to assist in determining mobility.

In view of the foregoing drawbacks, there may be a need to improve the mobility functionality in a network environment such as, for example, a heterogeneous network or any other suitable network. As such, it may be beneficial to provide an efficient and reliable mechanism for estimating the current or instant level of a mobile terminal (UE) mobility state which may be utilized for improving mobility management in one or more networks such as, for example, a heterogeneous network(s).

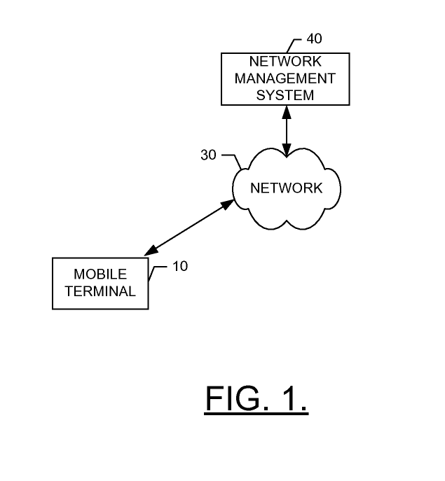

FIG. 1 illustrates a generic system diagram in which a device such as a mobile terminal 10, which may benefit from embodiments of the present invention, is shown in an example communication environment. As shown in FIG. 1, a system in accordance with an example embodiment of the present invention includes a communication device (e.g., mobile terminal 10) that may be capable of communication with a network 30. The mobile terminal 10 may be an example of one of several communications devices of the system that may be able to communicate with network devices or with each other via the network 30. In some cases, various aspects of operation of the network 30 may be managed by one or more network devices. As an example, the network 30 may include a network management system 40, which may be involved with (perhaps among other things) performing network management functions.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of voice and text communications systems, can readily employ embodiments of the present invention.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), LTE Advanced (LTE-A) or Evolved Universal Terrestrial Radio Access Network (E-UTRAN), Self Optimizing/Organizing Network (SON) intra-LTE, inter-Radio Access Technology (RAT) Network and/or the like.

One or more communication terminals such as the mobile terminal 10 and other communication devices may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the other communication devices via the network 30. By directly or indirectly connecting the mobile terminal 10 and the other communication devices to the network 30, the mobile terminal 10 and the other communication devices may be enabled to communicate with network devices and/or each other, for example, according to numerous communication protocols including Hypertext Transfer Protocol (HTTP) and/or the like, to thereby carry out various communication or other functions of the mobile terminal 10 and the other communication devices, respectively.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 30 and other devices by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the network management system 40 may be a device, node or collection of devices and nodes such as a server, computer or other network device. The network management system 40 may have any number of functions or associations with various services. As such, for example, the network management system 40 may be a platform such as a dedicated server (or server bank) associated with a particular information source or service (e.g., network management services), or the network management system 40 may be a backend server associated with one or more other functions or services. As such, the network management system 40 represents a potential host for a plurality of different network management services (e.g., mobility management services). In some embodiments, the functionality of the network management system 40 is provided by hardware and/or software components configured to operate in accordance with known techniques for the provision of network management services to the network 30. However, at least some of the functionality provided by the network management system 40 may be provided in accordance with example embodiments of the invention.

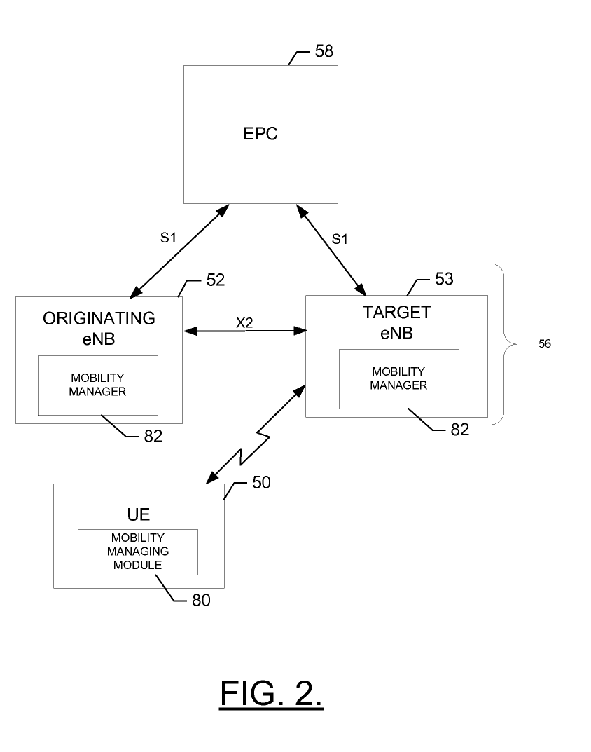

An example embodiment of the invention will now be described with reference to FIG. 2, in which certain elements of a system for providing mobility management are displayed. The system of FIG. 2 represents a specific embodiment of a network such as the general network displayed in FIG. 1, except that FIG. 2 represents a general block diagram of an E-UTRAN. As such, in connection with FIG. 2, user equipment (UE) 50 may be an example of one embodiment of the mobile terminal 10 of FIG. 1 and eNBs (E-UTRAN node Bs) 52 and 53 may be examples of base stations or access points that may serve respective cells or areas within the network 30 to, together with other eNBs, define the coverage provided by the network 30 to mobile users. However, it should be noted that the system of FIG. 2, may also be employed in connection with a variety of other devices, both mobile and fixed, and therefore, embodiments of the present invention should not be limited to application on devices such as the mobile terminal 10 of FIG. 1 or the network devices of FIG. 2. Moreover FIG. 2, which illustrates E-UTRAN components, should be understood to be just an example of one type of network with which embodiments of the present invention may be employed. However, other example embodiments may be practiced in similar fashion with respect to UTRAN or even other networks. Although one UE 50 and two eNBs 52 and 53 are shown in the system of FIG. 2, it should be pointed out that any suitable number of UEs 50 and eNBs 52 and 53 may be in the system of FIG. 2 without departing from the spirit and scope of the invention.

Referring now to FIG. 2, the system includes an E-UTRAN 56 which may include, among other things, a plurality of node-Bs in communication with an evolved packet core (EPC) 58 which may include one or more mobility management entities (MMEs) (not shown) and one or more system architecture evolution (SAE) gateways (not shown). The node-Bs may be E-UTRAN node-Bs (e.g., eNBs such as originating eNB 52 and target eNB 53) and may also be in communication with the UE 50 and other UEs. The E-UTRAN 56 may be in communication with the EPC 58. In an example embodiment, the network management system 40 of FIG. 1 may be an example of a device or collection of devices within the EPC 58 that may be configured to employ an example embodiment of the present invention. Each of the eNBs 52 and 53 may communicate with each other via an eNB to eNB interface such as, for example, an X2 interface. As referred to herein, an X2 interface may be a physical and/or logical interface between eNBs to facilitate communications between the eNBs. Additionally or alternatively, each of the eNBs 52 and 53 may communicate with each other via an S1 interface in which each eNB may send a message to the EPC 58. The EPC (also referred to herein as core network) may send the message to a corresponding eNB via an S1 interface. The S1 interface may be a physical and/or logical interface between eNBs and the EPC. In this regard, the eNBs and the EPC may communicate via the S1 interface. In an example embodiment, the eNBs 52 and/or 53 may determine whether a UE(s) is a good candidate for better optimized low mobility parameters (e.g., a non-moving UE(s)). In this regard, an eNB (e.g., eNB 52 or eNB 53) may provide a low-mobility time timer or value (also referred to herein as low-mobility timer or mobility timer) to a UE (e.g., UE 50). The UE (e.g., UE 50) may utilize this received timer in part to determine a mobility state of the LTE, as described more fully below. The originating eNB 52 may provide the low-mobility timer to the UE 50 in an instance in which the eNB 52 is currently serving the UE 50. On the other hand, the target eNB 53 may provide the low-mobility timer to the UE 50 in an instance in which the UE 50 is handed over by the originating eNB 52 to the target eNB 53.

In some example embodiments, instances of a mobility manager 82 may be present at each of the eNBs 52 and 53 to control mobility management of a UE(s), as described in greater detail below. However, it should be appreciated that in some embodiments, rather than employing instances of the mobility manager 82 at each respective eNB, the EPC 58 may employ an instance of the mobility manager 82 and direct operations of the eNBs accordingly.

The eNBs 52 and 53 may provide E-UTRA user plane and control plane (radio resource control (RRC)) protocol terminations for the UE 50. The eNBs 52 and 53 may provide functionality hosting for such functions as radio resource management, radio bearer control, radio admission control, connection mobility control, dynamic allocation of resources to UEs in both uplink and downlink, selection of an MME at LTE attachment, IP header compression and encryption, scheduling of paging and broadcast information, routing of data, measurement and measurement reporting for configuration mobility, and the like.

The MME may host functions such as distribution of messages to respective node-Bs, security control, idle state mobility control, EPS (Evolved Packet System) bearer control, ciphering and integrity protection of (non access stratum) NAS signaling, and the like. The SAE gateway may host functions such as termination and switching of certain packets for paging and support of UE mobility. In an example embodiment, the EPC 58 may provide connection to a network such as the Internet. As shown in FIG. 2, the eNBs 52 and 53 may each include a mobility manager 82 configured to execute functions associated with each corresponding eNB with respect to receiving information from and/or providing information to the UE 50, the EPC 58 and/or other eNBs related to, for example, communication format parameters and/or mobility parameters related to mobility management and any other suitable information.

In an example embodiment, the system of FIG. 2 may include one or more public land mobile networks (PLMNs) coupled to one or more other data or communication networks—notably a wide area network (WAN) such as the Internet. Each of the PLMNs may include a core network backbone such as the EPC 58. Each of the core networks and the Internet may be coupled to one or more radio access networks, air interfaces or the like that implement one or more radio access technologies. The radio access networks may each include one or more base stations (e.g., eNBs 52 or 53), access points or the like, each of which may serve a coverage area divided into one or more cells. In some cases, eNBs 52 and 53 may be associated with the same PLMN or equivalent PLMNs. In such cases, any mobility information provided to either eNB may still be useful to the corresponding PLMN.

In one example embodiment, the system of FIG. 2 may, but need not, include a heterogeneous network which may include one or more cells (e.g., small cells, macrocells, picocells, femtocells, etc.). In this regard, one or more eNBs of the system of FIG. 2 may determine beneficial mobility state information based in part on detecting whether a UE is non-moving (e.g., moving very slowly or not moving at all) or moving. As such, some example embodiments may utilize two distinct states (moving or not moving) to determine mobility state information. In this manner, in some example embodiments there may not necessarily be a need for three classes of mobility (e.g., low mobility, medium mobility, high mobility) as utilized in current/existing approaches.

It should be noted that the terms “originating” and “target” are merely used herein to refer to roles that any eNB may play at various different times in relation to being a source (e.g., originating) cell initially providing service to a UE or a neighboring or destination or (e.g., target) cell to which service is to be transferred to, for example, the UE moving from the source cell to the neighboring or destination cell. Thus, the terms “originating” and “target” could be applicable to the same eNB at various different times and such terms are not meant to be limiting in any way.

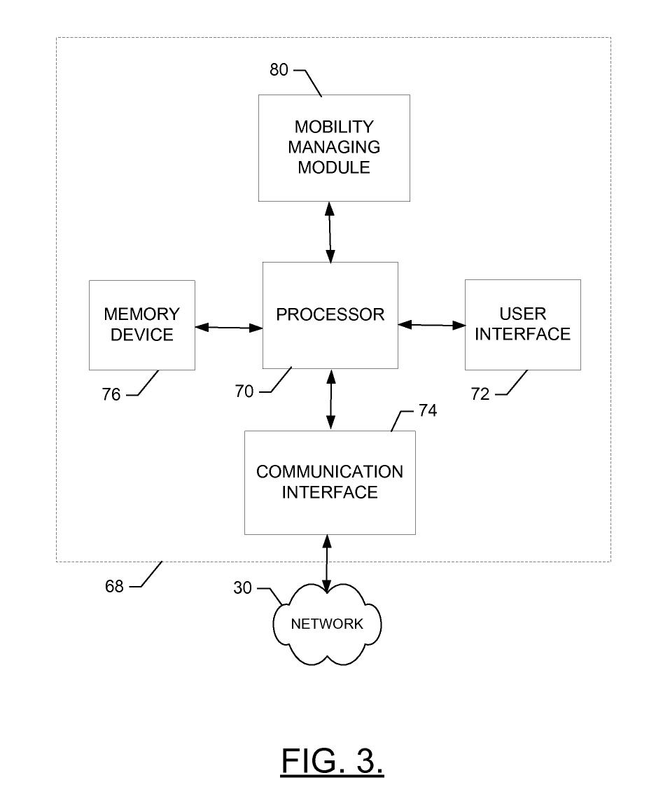

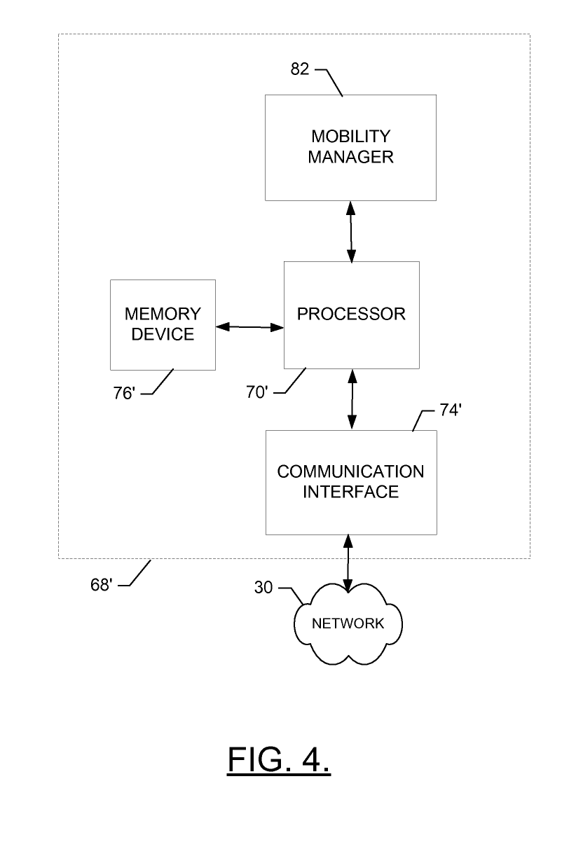

FIGS. 3 and 4 illustrate block diagrams of apparatuses for providing mobility management and determining one or more mobility states according to an example embodiment. The apparatus of FIG. 3 may be employed, for example, on the mobile terminal 10. Meanwhile, the apparatus of FIG. 4 may be employed, for example, on the network management system 40, the EPC 58 or on the eNBs 52 and 53. However, the apparatus may alternatively be embodied at a variety of other devices. In some cases, embodiments may be employed on either one or a combination of devices. Furthermore, it should be noted that the devices or elements described below may not be mandatory and thus some may be omitted in certain embodiments.

Referring now to FIG. 3, an apparatus 68 for providing mobility management and determining one or more mobility states is provided. The apparatus 68 may include or otherwise be in communication with a processor 70, a user interface 72, a communication interface 74, a memory device 76 and a mobility managing module 80. In some embodiments, the processor 70 (and/or co-processors or any other processing circuitry assisting or otherwise associated with the processor 70) may be in communication with the memory device 76 via a bus for passing information among components of the apparatus 68. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 68 may, in some embodiments, be a mobile terminal (e.g., mobile terminal 10 (e.g., a UE 50)) or a fixed communication device or computing device configured to employ an example embodiment of the invention. However, in an example embodiment, the apparatus 68 may be embodied as a chip or chip set. In other words, the apparatus 68 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 68 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 68. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the mobility managing module 80. As such, in some embodiments, the processor 70 may be said to cause, direct or control the execution or occurrence of the various functions attributed to the mobility managing module 80, as described herein. The mobility managing module 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the mobility managing module 80, as described herein. Thus, in examples in which software is employed, a device or circuitry (e.g., the processor 70 in one example) executing the software forms the structure associated with such means.

The mobility managing module 80 may be invoke a low mobility timer received from an eNB (e.g., eNB 52, eNB 53) and may determine a mobility of the apparatus 68 based in part on utilizing the time period associated with the low mobility timer, as described more fully below.

As indicated above, FIG. 4 illustrates a block diagram of an apparatus 68′ for providing mobility management from the perspective of a network entity. The apparatus 68′ may be employed, for example, on the eNBs 52, 53. In an alternative example embodiment, the apparatus 68′ may be employed, for example, on the network management system 40 or on EPC 58. The apparatus 68′ may include several components similar to those of the apparatus 68 of FIG. 3. In this regard, for example, the apparatus 68′ may include components such as a processor 70′, a memory device 76′ and a communication interface 74′ as shown in the example of FIG. 4. The processor 70′, the memory device 76′ and the communication interface 74′ may have similar structural characteristics and functional capabilities to the processor 70, memory device 76 and communication interface 74 of FIG. 3 except perhaps as to scale and semantic differences. Accordingly, a detailed description of these components will not be provided.

In an example embodiment, the apparatus 68′ may further include a mobility manager 82. In some cases, the processor 70′ may be embodied as, include or otherwise control the mobility manager 82. As such, in some embodiments, the processor 70′ may be said to cause, direct or control the execution or occurrence of the various functions attributed to the mobility manager 82, as described herein. The mobility manager 82 may be any means such as a device or circuitry operating in accordance with software or otherwise embodied in hardware or a combination of hardware and software (e.g., processor 70′ operating under software control, the processor 70′ embodied as an ASIC or FPGA specifically configured to perform the operations described herein, or a combination thereof) thereby configuring the device or circuitry to perform the corresponding functions of the mobility manager 82, as described herein. Thus, in examples in which software is employed, a device or circuitry (e.g., the processor 70′ in one example) executing the software forms the structure associated with such means.

The mobility manager 82 may be configured to generate and provide a low mobility timer to one or more UEs (e.g., UE 50). The low mobility timer may be generated by the mobility manager 82 based in part on a specific cell in which a corresponding UE (e.g., UE 50) is operating, as described more fully below. The UE may utilize a time period/value associated with the low mobility timer to determine a mobility of the UE, as described more fully below. The UE may provide the mobility manager 82 with an indication of the expiration of the time period associated with the low mobility timer. Additionally, the UE may provide the mobility manager 82 with an indication as to the mobility state(s) of the UE.

As described above, in order to determine one or more candidate UEs for better optimized low mobility parameters (e.g., non-moving UEs), the eNB 52 and/or eNB 53 may generate and provide a low mobility timer to a UE(s) (e.g., UE 50). In this regard, the low mobility timer may be received and utilized by a UE(s) (e.g., UE 50) such that in an instance in which the UE(s) enters a cell (e.g., a target cell of eNB 53), the UE (e.g., UE 50) may start the time or time period associated with the low mobility timer.

In an instance in which a mobility managing module 80 and/or processor 70 of a UE (e.g., UE 50), receiving the low mobility timer, does not change cells while the low mobility timer is running or invoked, the mobility managing module 80 and/or processor 70 of the UE may determine that the mobility of the UE is low. The mobility managing module 80 and/or processor 70 of a UE may determine that the UE 50 does not change cells in an instance in which the mobility managing module 80 and/or processor 70 determines that the UE stays/remains within the corresponding cell (e.g., a serving cell) during the defined time period associated with the low mobility timer. In this regard, the managing mobility module 80 and/or processor 70 of the UE may designate itself as being a low mobility UE.

In an instance in which the mobility managing module 80 and/or processor 70 of the UE 50 determines that the time period associated with the low mobility timer has expired, the mobility managing module 80 and/or processor 70 of the UE 50 may determine that a mobility of the UE 50 is semi-static/non-moving. Additionally, the mobility managing module 80 and/or processor 70 of UE 50 may inform an eNB (e.g., eNB 53) of a corresponding cell (e.g., target cell) about the expiry of the time period associated with the low mobility timer.

While the time period associated with the low mobility timer is running, the mobility managing module 80 and/or processor 70 of the UE 50 may determine that the mobility state of the UE 50 is in the same mobility state that the UE 50 was in prior to starting the low mobility timer. For example, in an instance in which the UE 50 was in a low mobility state when starting the low mobility timer, the mobility managing module 80 and/or processor 70 of the UE 50 may continue to determine that the UE 50 is in the low mobility state until a new decision regarding the mobility of the UE 50 is determined. The new decision regarding the mobility of the UE 50 may be determined by the mobility managing module 80 and/or the processor 70 upon the expiration of the time period associated with the low mobility timer.

In an example embodiment, the time period or value of the low mobility timer may be cell specific. In this regard, the mobility manager 82 and/or processor 70′ of an eNB (e.g., eNB 53) may generate the low mobility timer based in part on one or more parameters or attributes of a particular cell (e.g., a target cell) of a serving eNB (e.g., eNB 53). For purposes of illustration and not of limitation, the mobility manager 82 and/or processor 70′ may generate the low mobility timer based in part on the cell size and cell type (e.g., macrocells, picocells, femtocells,_small cells, etc.) of a corresponding serving cell.

The mobility manager 82 and/or the processor 70′ of an eNB may provide the low mobility timer to the UE 50 in a handover command (for e.g., in a connected mode (e.g., a LTE RRC Connected mode)) or in any other suitable manner (e.g., other commands, etc.). In another example embodiment, the mobility manager 82 and/or the processor 70′ of an eNB may include the low mobility timer in a broadcast message that is provided to UE 50 (e.g., in an idle mode (e.g., an LTE IDLE mode)) or in any other suitable manner (e.g., other messages, etc.).

As described above, the actual setting and decision of the timer length (e.g., time period or value) of the low mobility timer may be determined by an eNB (e.g., eNB 52, eNB 53). In an alternative example embodiment, the actual setting and decision of the timer length (e.g., time period or value) of the low mobility timer may be determined by another network device (e.g., network management system 40, EPC 58). The actual setting and decision of the timer length (e.g., time period or value) of the low mobility timer determined by an eNB (e.g., eNB 52, eNB 53) or another network device (e.g., network management system 40, EPC 58) may be supported by network self-optimizing procedures such as, for example, self-optimizing network (SON) or mobility robustness optimization (MRO). In an instance in which a timer length of a low mobility timer is determined by an eNB or another network device, the low mobility timer may be provided to one more UEs (e.g., UEs 50). In an example embodiment, an eNB and/or another network device may provide the low mobility timer to a UE(s) (e.g., a UE 50) in a system information block (SIB) or in dedicated signaling (e.g., handover signaling, configuration change signaling, etc.)

The mobility managing module 80 of an eNB may determine the timer value (e.g., a time period) of the low mobility timer based in part on a cell size, cell type and any other suitable cell specific information associated with a corresponding cell. The corresponding cell may be a cell currently servicing the UE (e.g., UE 50).

In an instance in which a UE 50 enters a cell (e.g., a target cell of target eNB 53), a mobility managing module 80 of the UE 50 (through handover in Connected mode or re-selection in IDLE mode) may start the time period associated with the low mobility timer. In an example embodiment, the UE 50 may enter a cell (e.g., a target cell) in an instance in which the UE 50 is handed over, (e.g., in a Connected mode (e.g., in a LTE RRC Connected mode) or re-selection in IDLE mode (e.g., LTE IDLE mode)), by the originating eNB 52 of a source cell to a target eNB 53 of a target cell or neighbor cell. In another alternative example embodiment, the UE 50 may enter a cell upon being started up (e.g., turned on), or currently operating, in a cell (e.g., a source/origin cell of originating eNB 52) in which the UE 50 may be currently located.

In an instance in which the mobility managing module 80 of the UE 50 detects that the UE 50 changes cells prior to expiration of the time period associated with the low mobility timer (e.g., a cell change while the time period of the low mobility timer is active) the mobility managing module 80 of the UE 50 may change its mobility state to ‘moving’ (also referred to herein as a moving mobility state). In this regard, for example, the mobility managing module 80 of the UE 50 may determine that the UE 50 is no longer in a non-moving mobility state. The mobility managing module 80 of the UE 50 may determine that the UE 50 changes cells in an instance in which the mobility managing module 80 determines that the UE 50 moves to another different cell (e.g., a neighbor cell) prior to expiration of the time period associated with the low mobility timer.

On the other hand, in an instance in which the mobility managing module 80 of a UE 50 determines that the time period associated with the low mobility timer expires without any cell change by the UE 50 (e.g., the timer expires within same cell in which the timer was started), the mobility managing module 80 of the UE 50 may determine that the mobility state of the UE 50 is in a non-moving state (also referred to herein as a non-moving mobility state). The mobility managing module 80 of the UE 50 may determine that the time period expires without any cell change in an instance in which the mobility managing module 80 determines that the time period of the low mobility timer expires while the UE 50 remains/stays within same cell in which the UE 50 was located in upon invoking or starting the time period of the low mobility timer.

In response to the time period associated with the low mobility time expiring, the mobility managing module 80 of the UE 50 may change its state (e.g., mobility state), as described above, and may perform one or more actions that are determined according to that state. The mobility managing module 80 may report the expiration of the time period of the low mobility timer to an eNB (e.g., eNB 52, eNB 53) or another network device (e.g., network management system 40, EPC 58). In response to receipt of the expiration of the time period associated with the low mobility timer, the eNB or other network device may take appropriate actions. The actions triggered by the expiration of the time period associated with the low mobility timer may relate to various aspects of UE 50 and network behavior.

Although the example(s) above may relate to an application of an example embodiment pertaining to E-UTRAN, other example embodiments may be practiced in similar fashion with respect to UTRAN or even other networks.

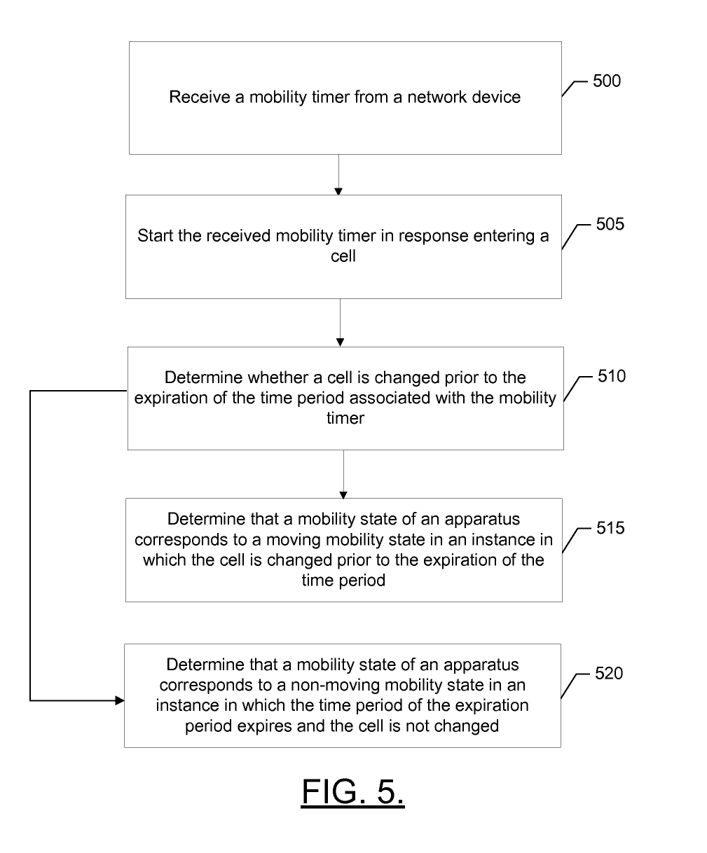

Referring now to FIG. 5, a flowchart of a method and program product for facilitating mobility management according to an example embodiment is provided. At operation 500, an apparatus (e.g., UE 50) may receive a mobility timer (e.g. also referred to herein as low mobility timer) from a network device (e.g., an eNB (e.g., eNB 52, eNB 53), network management system 40, EPC 58). The mobility timer may be received in a SIB, and/or dedicated signaling (e.g., handover signaling (e.g., a handover message), configuration change signaling) or in any other suitable manner. At operation 505, the apparatus (e.g., UE 50) may start a time period (e.g., a value (e.g., a time value)) associated with the received mobility timer in response to entering a cell (e.g., handover to a target cell of the target eNB 53). In an example embodiment, an apparatus (e.g., UE 50) may determine that it entered a cell upon being handed over from a source cell (e.g., source cell of originating eNB 52) to a target cell (e.g., target cell of target eNB 53). Alternatively, an apparatus (e.g., UE 50) may determine that it entered a cell upon startup of the apparatus in a source cell (e.g., source cell of originating eNB 52) in which the apparatus is currently located and operating. At operation 510, an apparatus (e.g., UE 50) may determine whether a cell is changed (e.g., the apparatus moves from one cell to another cell) prior to the expiration of the time period associated with the mobility timer. The apparatus (e.g., UE 50) may determine that the cell is changed in response to determining that the apparatus moves from one cell (e.g., a target cell of target eNB 53) to another cell (e.g., a source cell of originating eNB 52, etc.).

At operation 515, an apparatus (e.g., UE 50) may determine that a mobility state of the apparatus corresponds to a moving mobility state in an instance in which the apparatus determines that the cell is changed prior to the expiration of the time period. At operation 520, an apparatus (e.g., UE 50) may determine that a mobility state of the apparatus corresponds to a non-moving mobility state in an instance in which the time period of the mobility timer expires and the cell is not changed.

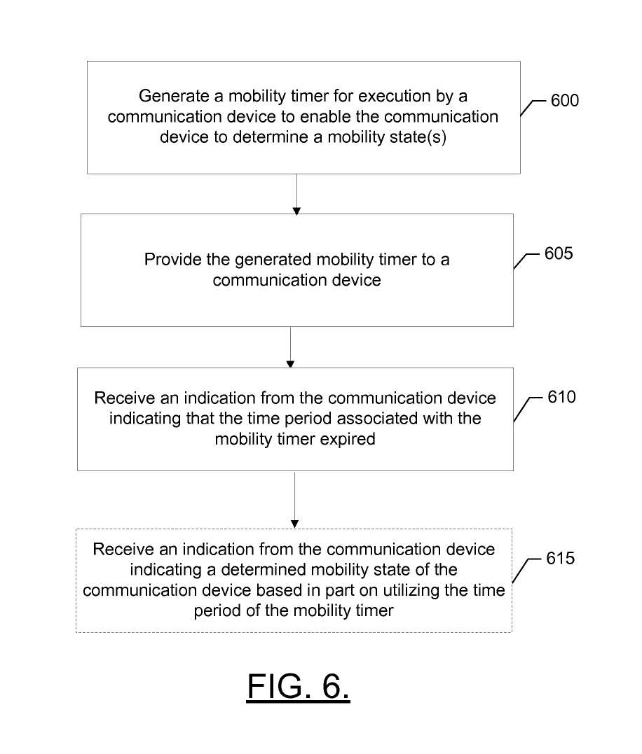

Referring now to FIG. 6, a flowchart of a method and program product for facilitating mobility management according to an example embodiment is provided. At operation 600, an apparatus (e.g., eNB 52, or eNB 53) may generate a mobility timer for execution by a communication device (e.g., UE 50) to enable the communication device to utilize the mobility timer in part to determine a mobility state(s). The apparatus (e.g., eNB 52, or eNB 53) may generate the mobility timer based in part on one or more attributes/parameters (e.g., a cell size, cell type, etc.) of a particular/specific cell serving (e.g., a target/neighbor cell) the communication device. At operation 605, an apparatus (e.g., an eNB 52, eNB 53) may provide the generated mobility timer to a communication device (e.g., UE 50). The apparatus may provide the mobility timer to the communication device (e.g., UE 50) in a SIB, in dedicated signaling (e.g., handover signaling (e.g., a handover message), configuration change signaling, etc.) or in any other suitable manner.

At operation 610, an apparatus (e.g., an eNB 52, or eNB 53) may receive an indication from the communication device (e.g., UE 50) indicating that the time period associated with the mobility timer expired. Optionally, at operation 615, an apparatus (e.g., eNB 52, or eNB 53) may receive an indication from the communication device (e.g., UE 50) indicating a determined mobility state (e.g., a non-moving mobility state or a moving mobility state) of the communication device (e.g., UE 50) based in part on utilizing the time period of the mobility timer.

It should be pointed out that FIGS. 5 and 6 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory device 76′) and executed by a processor (e.g., processor 70, processor 70′, mobility managing module 80, mobility manager 82). As will be appreciated, any such computer program instructions may be loaded onto a computer or other programmable apparatus (e.g., hardware) to produce a machine, such that the instructions which execute on the computer or other programmable apparatus cause the functions specified in the blocks of the flowcharts to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the blocks of the flowcharts. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the blocks of the flowcharts.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5 and 6 above may comprise a processor (e.g., the processor 70, processor 70′, mobility managing module 80, mobility manager 82) configured to perform some or each of the operations (500-520 and 600-615) described above. The processor may, for example, be configured to perform the operations (500-520 and 600-615) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (500-520 and 600-615) may comprise, for example, the processor 70 (e.g., as means for performing any of the operations described above), the processor 70′, the mobility managing module 80, the mobility manager 82 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-34. (canceled)

35. A method comprising:
receiving a mobility timer from a network device;
starting, via an apparatus, a time period of the received mobility timer in response to entering a cell; and
determining whether the cell is changed to a different cell prior to expiration of the time period associated with the mobility timer.

36. The method of claim 35, further comprising:
determining that a mobility state of the apparatus corresponds to a moving mobility state in an instance in which the cell is changed to the different cell prior to, or upon, the expiration of the time period.

37. The method of claim 35, further comprising:
determining that a mobility state of the apparatus corresponds to a non-moving mobility state in an instance in which the time period of the mobility timer expires and the cell is unchanged.

38. An apparatus comprising:
at least one processor; and
at least one memory including computer program code configured to, with the at least one processor, cause the apparatus to perform at least the following:
receive a mobility timer from a network device;
start a time period of the received mobility timer in response to entering a cell; and
determine whether the cell is changed to a different cell prior to expiration of the time period associated with the mobility timer.

39. The apparatus of claim 38, wherein the memory and computer program code are further configured to, with the processor, cause the apparatus to:
determine that a mobility state of the apparatus corresponds to a moving mobility state in an instance in which the cell is changed to the different cell prior to, or upon, the expiration of the time period.

40. The apparatus of claim 39, wherein the memory and computer program code are further configured to, with the processor, cause the apparatus to:
determine that the cell is changed to the different cell in response to detecting that the apparatus moves from the cell to the different cell or is handed over from the cell to the different cell.

41. The apparatus of claim 38, wherein the memory and computer program code are further configured to, with the processor, cause the apparatus to:
determine that a mobility state of the apparatus corresponds to a non-moving mobility state in an instance in which the time period of the mobility timer expires and the cell is unchanged.

42. The apparatus of claim 41, wherein the non-moving mobility state denotes that the apparatus is moving slow or that the apparatus is not moving.

43. The apparatus of claim 38, wherein entering the cell comprises at least one of the apparatus being handed over to the cell from another cell, the apparatus being turned on in the cell or the apparatus being currently operated in the cell.

44. The apparatus of claim 38, wherein the cell comprises at least one of a macrocell, a picocell, or a femtocell of a heterogeneous network.

45. The apparatus of claim 38, wherein the cell comprises a serving cell facilitating communications of the apparatus.

46. The apparatus of claim 38, wherein:
the time period of the mobility timer received from the network device is generated by the network device based in part on one or more attributes of the cell.

47. The apparatus of claim 46, wherein the attributes of the cell comprises at least one of a size of the cell or a type of the cell.

48. The apparatus of claim 38, wherein the memory and computer program code are configured to, with the processor, cause the apparatus to:
receive the mobility timer by receiving the mobility timer in at least one of a handover command, a broadcast message, a system information block, a dedicated signal, or a configuration change signal from the network device.

49. The apparatus of claim 38, wherein the memory and computer program code are further configured to, with the processor, cause the apparatus to:
change a mobility state of the apparatus to a moving mobility state in response to detecting a change from the cell to the different cell prior to the expiration of the time period associated with the mobility timer.

50. The apparatus of claim 38, wherein the memory and computer program code are further configured to, with the processor, cause the apparatus to:
enable provision of an indication to the network device indicating that the time period of the mobility timer expired to trigger the network device to take one or more actions on behalf of the apparatus.

51. The apparatus of claim 38, wherein the memory and computer program code are further configured to, with the processor, cause the apparatus to:
enable provision of an indication to the network device indicating a determined mobility state of the apparatus.

52. The apparatus of claim 51, wherein the memory and computer program code are configured to, with the processor, cause the apparatus to:
perform the indicating of the determined mobility state by indicating whether the apparatus is in a moving mobility state or a non-moving mobility state.

53. A computer program product comprising at least one non-transitory computer-readable storage medium having computer-readable program code portions stored therein, the computer-readable program code portions comprising:
program code instructions configured to facilitate receipt of a mobility timer from a network device;
program code instructions configured to start, via an apparatus, a time period of the received mobility timer in response to entering a cell; and
program code instructions configured to determine whether the cell is changed to a different cell prior to expiration of the time period associated with the mobility timer.

54. The computer program product of claim 53, further comprising:
program code instructions configured to determine that a mobility state of the apparatus corresponds to a non-moving mobility state in an instance in which the time period of the mobility timer expires and the cell is unchanged.
